(19) United States
(12) Patent Application Publication
(10) Pub. No.: US 2026/0049528 A1
(43) Pub. Date: Feb. 19, 2026

(54) SERIAL TYPE MULTI ROLL BLIND

(71) Applicant: WINTEC KOREA INC., Gwangju-si, Gyeonggi-do (KR)

(72) Inventor: Seong-ryong JANG, Seoul (KR)

(21) Appl. No.: 19/101,597

(22) PCT Filed: Apr. 18, 2023
(86) PCT No.: PCT/KR2023/005241

§ 371 Date: Feb. 6, 2025

(30) Foreign Application Priority Data
Aug. 12, 2022 (KR) 10-2022-0101495

(51) Int. Cl. E06B 9/64; E06B 9/24; E06B 9/42; E06B 9/60; E06B 9/72

(52) U.S. Cl. CPC E06B 9/64; E06B 9/42; E06B 9/60; E06B 9/72; E06B 2009/2441

(57) ABSTRACT

A serial type multi roll blind is provided. The serial type multi roll blind includes: a weight bar, a first screen that has a lower end connected to the weight bar and an upper end connected to a first winding roll and is wound on the first winding roll or unwound from the first winding roll by rotation of the first winding roll, a first winding bar in which the first winding roll is rotatably coupled, a second screen that has a lower end connected to the first winding bar and an upper end connected to a second winding roll and is wound on the second winding roll or unwound from the second winding roll by rotation of the second winding roll, and a first winding bar in which the first winding roll is rotatably coupled.

### TECHNICAL FIELD

The present disclosure relates to a roll blind that is used with a screen rolled or unrolled, and, more specifically, to a serial type multi roll blind that can apply two or more kinds of continuously connected screens selectively or simultaneously to one window.

### BACKGROUND ART

A blind apparatus is one of sunlight blocking equipment that is installed over a window. Since blind apparatus are easy to operate and simple to install in comparison to conventional curtains or shades, they are usually used at home as well as in offices.

Blind apparatuses are classified into various types such as a wood blind that blocks the sunlight by adjusting the angle of slats, double screen-type combi blinds having an opaque part and transparent part that overlap each other, a roll blind having a roll screen that adjusts the amount of light by being wound on or unwound from a roll. Further, improved blinds (e.g., Korean Patent No. 10-0866344) developed from these blinds are also being continuously developed.

However, such blinds of the related art have the following problems in common. Since the structures of the related art are designed to cover a window to block the sunlight, there is a problem that when the amount of light is to be reduced, a window is shielded and it is impossible to see the view outside the window.

Meanwhile, when a window is tinted, the sunlight is not fully blocked, so there is a problem that it is required to additionally use equipment for blocking the sunlight such as a blind or a curtain.

Further, it is difficult to operate blinds of the related art in a customized type, for example, dividing one window into a part blocking light, a tinted part, and a part transmitting light, so there is a problem that it is difficult to satisfy various demands of users including such a demand. There is Korean Patent No. 10-0866344 as a related art.

### DISCLOSURE OF INVENTION

### Technical Problem

The present disclosure has been made in an effort to solve these problems, and an objective of the present disclosure is to provide a serial type multi roll blind that can apply two or more kinds of continuously connected screens selectively or simultaneously to one window.

The objectives of the present disclosure are not limited to those described above and other objectives may be made apparent to those skilled in the art from the following description.

### Solution to Problem

A serial type multi roll blind according to the present disclosure includes: a weight bar; a first screen that has a lower end connected to the weight bar and an upper end connected to a first winding roll and is wound on the first winding roll or unwound from the first winding roll by rotation of the first winding roll; a first winding bar in which the first winding roll is rotatably coupled; a second screen that has a lower end connected to the first winding bar and an upper end connected to a second winding roll and is wound on the second winding roll or unwound from the second winding roll by rotation of the second winding roll; and a second winding bar in which the second winding roll is rotatably coupled.

The first winding bar may include a torsion spring that is connected to the first winding roll and generates first torque while being compressed by rotation of the first winding roll, thereby offsetting second torque that is generated in the opposite direction to the first torque by the weight of the first screen and the weight bar in rotation.

The first screen may be naturally fixed in an unwound state or a wound state by balance of the first torque and the second torque.

The serial type multi roll blind may further include a holder disposed at the weight bar to be able to fix the weight bar to a side of a window frame.

The second winding bar may further include a rotation actuator adjusting positions of the second screen and the first winding bar by applying a rotation force to the second winding roll.

The rotation actuator may include a remotely controllable driving motor.

The first screen and the second screen may be different in light transmissivity.

Any one of the first screen and the second screen may be made of a translucent sheet that can transmit light, and the other one may be made of an opaque sheet.

The translucent sheet may be a transparent film having light transmissivity adjusted through tinting.

The first screen may be made of a translucent sheet and the second screen may be made of an opaque sheet.

### Advantageous Effects of Invention

According to the present disclosure, it is possible to block the sunlight or adjust the amount of light by applying at least two kinds of continuously connected screens to one window. Using the present disclosure, it is also possible to block the sunlight using an opaque screen, to see the view outside a widow while giving a tinting effect using a translucent screen, and to transmit the sunlight by fully winding up a screen itself. Further, by longitudinally dividing one window using continuously connected screens, customized operation can also be achieved such as blocking a portion of a window, tinting a portion, and transmitting the sunlight through a portion. Accordingly, it is possible to use the blind in various ways and satisfy various users'demands in various situations.

### BRIEF DESCRIPTION OF DRAWINGS

FIG. 1 is a perspective view of a serial type multi roll blind of the present disclosure.

FIG. 2 is a perspective view exemplifying the operation of the roll blind of FIG. 1.

FIG. 3 is a partial cross-sectional view showing the internal structure of a first winding bar of the roll blind of FIG. 1.

FIG. 4 is a partial cross-sectional view showing the internal structure of a second winding bar of the roll blind of FIG. 1.

FIG. 5 is an operation view exemplifying the operation of the second winding bar and the second screen of the roll blind of FIG. 1.

FIGS. 6 and 7 are operation views exemplifying the operation of the first winding bar and the first screen of the roll blind of FIG. 1.

FIG. 8 is an operation view showing the operation of the roll blind of FIG. 1 step by step with a weight bar fixed.

### MODE FOR THE INVENTION

The advantages and features of the present disclosure, and methods of achieving them will be clear by referring to the exemplary embodiments that will be described hereafter in detail with reference to the accompanying drawings. However, the present disclosure is not limited to the exemplary embodiments described hereafter and may be implemented in various ways. The exemplary embodiments are provided to complete the description of the present disclosure and let those skilled in the art completely know the scope of the present disclosure, and the present disclosure is defined only by the claims. Like reference numerals indicate the same components throughout the specification.

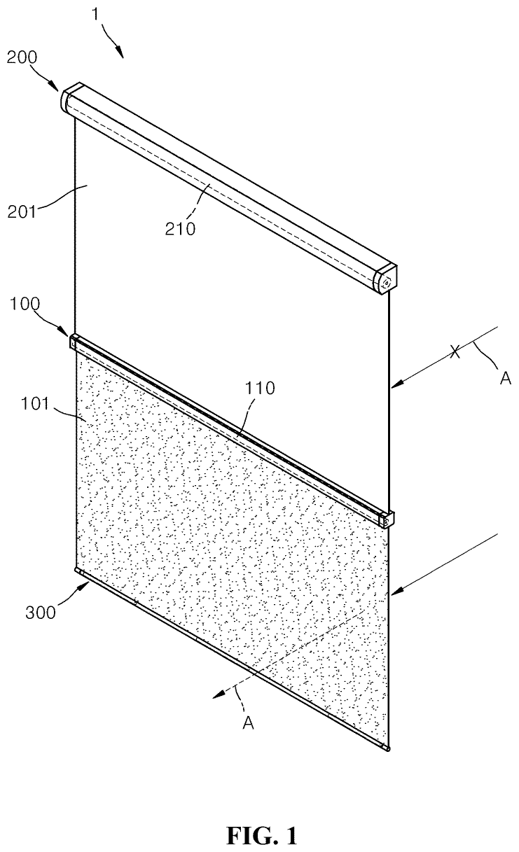

Hereafter, a serial type multi roll blind according to the present disclosure is described in detail with reference to FIGS. 1 to 8.

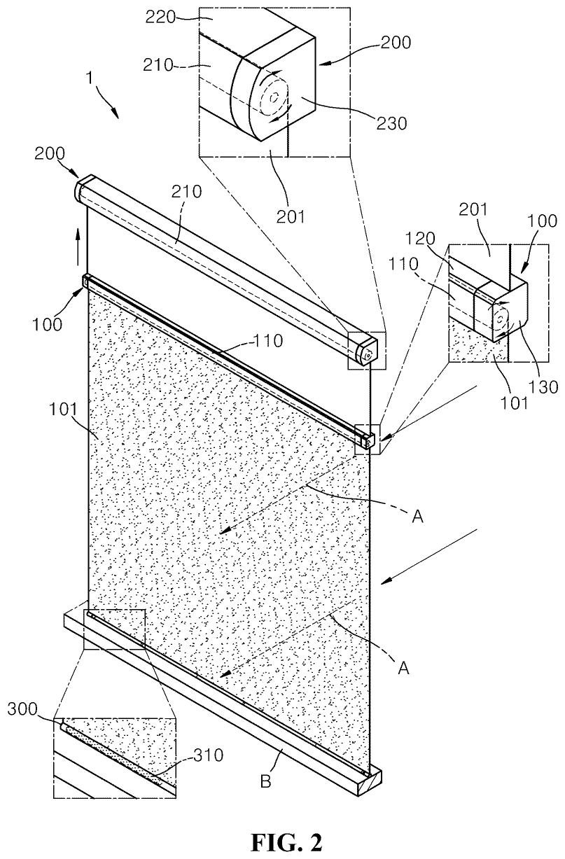

FIG. 1 is a perspective view of a serial type multi roll blind of the present disclosure, and FIG. 2 is a perspective view exemplifying the operation of the roll blind of FIG. 1.

Referring to FIG. 1, a serial type multi roll blind 1 (hereafter, a roll blind) according to the present disclosure is configured such that a first screen 101 and a second screen 201 are connected in series with a first winding bar 100 therebetween (a screen is connected to an end of another screen). Accordingly, it is possible to simultaneously operate two connected screens by rotating one winding roll (e.g., a second winding roll 210).

However, winding rolls (a first winding roll 110 and a second winding roll 210) for operating the screens, respectively, are independent from each other, so the areas of the first screen 101 and the second screen 201 can be independently adjusted. That is, in addition to the state exemplified in FIG. 1, it is possible to use the roll blind with the second screen 201 wound and only the first screen 101 extended or with the first screen 101 wound and only the second screen 201 extended, and it is possible to arrange the first screen 101 and the second screen 201 with their ratio appropriately adjusted or to fully expose a window by winding both of the two screens.

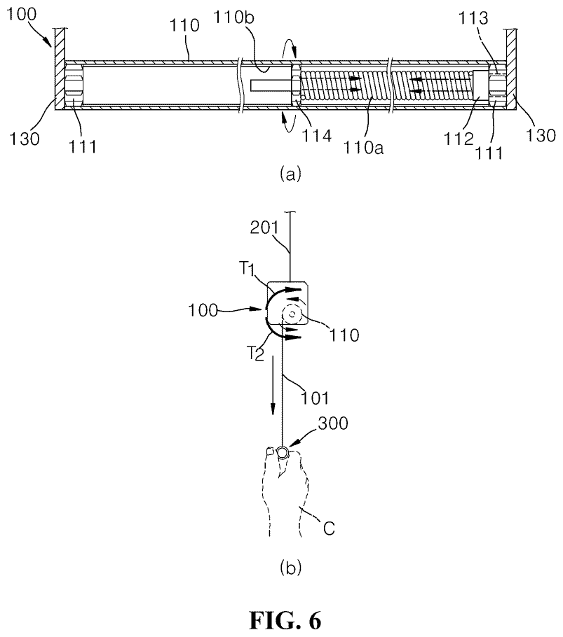

In particular, torque is generated in a pair in opposite directions when the first winding roll 110 is rotated, and the first winding roll 110 is balanced in all rotation angles, so it is easily operated even by a small force. For example, the first screen 101 is easily extended even though the lower end of the first screen 101 is pulled (see FIG. 6) by a small external force or the upper end of the first screen 101 is pulled by a small external force with the lower end fixed (see FIG. 2), and when the external force is removed, the first screen 101 is naturally fixed in the corresponding state.

By using this configuration, as shown in FIG. 2, it is possible to simultaneously change the areas of the first screen 101 and the second screen 201 by fixing the lower end of the first screen 101 (i.e., a weight bar 300) to a window frame B and pulling the second screen 201 using the second winding roll 210. The first screen 101 and the second screen 201 are made of materials having different light transmissivities (a translucent sheet and an opaque sheet), so it is possible to achieve an effect of blocking light A by the opaque sheet, a tinting effect by the translucent sheet, etc. at desired ratios by adjusting the areas of the screens.

The roll blind 1 of the present disclosure is configured as follows. The roll blind 1 of the present disclosure includes: a weight bar 300, a first screen 101 that has a lower end connected to the weight bar 300 and an upper end connected to a first winding roll 110 and is wound on the first winding roll 110 or unwound from the first winding roll 110 by rotation of the first winding roll 110; a first winding bar 100 in which the first winding roll 110 is rotatably coupled; a second screen 210 that has a lower end connected to the first winding bar 100 and an upper end connected to a second winding roll 210 and is wound on the second winding roll 210 or unwound from the second winding roll 210 by rotation of the second winding roll 210; and a second winding bar 200 in which the second winding roll 210 is rotatably coupled.

In an embodiment of the present disclosure, the first winding bar 100 may include a torsion spring (see 110a in FIG. 6) that is connected to the first winding roll 110 and generates first torque (see T1 in FIG. 6) while being compressed by rotation of the first winding roll 110, thereby offsetting second torque (see T2 in FIG. 6) that is generated in the opposite direction to the first torque by the weight of the first screen 101 and the weight bar 300 in the rotation.

Accordingly, the first screen 101 can be naturally fixed in an unwound state or a wound state by balance of the first torque and the second torque.

Further, the light transmissivities of the first screen 101 and the second screen 201 may be different, and any one of the first screen 101 and the second screen 201 may be made of a translucent sheet that can transmit light and the other one may be made of an opaque sheet.

The configuration and operation effects of the present disclosure are described hereafter in more detail on the basis of an embodiment of the present disclosure.

### First, the Structure of the Roll Blind Is Described in Detail With Reference to FIGS. 1 to 4.

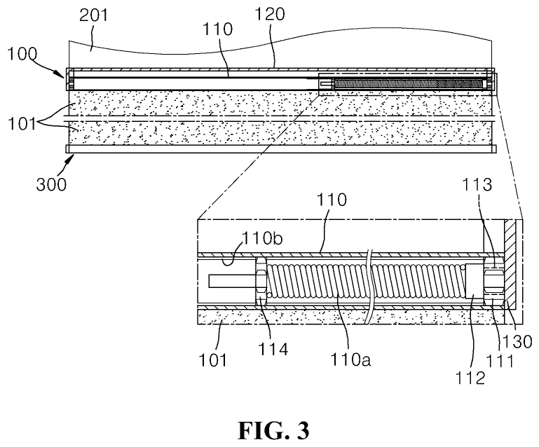

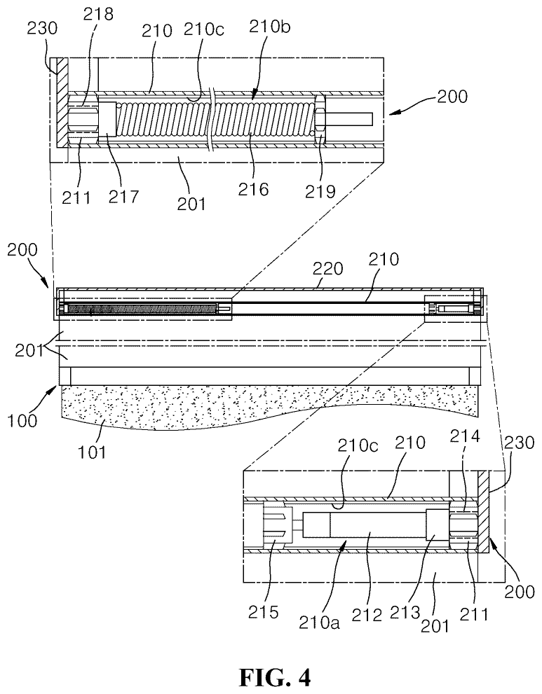

FIG. 3 is a partial cross-sectional view showing the internal structure of a first winding bar of the roll blind of FIG. 1, and FIG. 4 is a partial cross-sectional view showing the internal structure of a second winding bar of the roll blind of FIG. 1.

As shown in FIG. 1, the roll blind 1 of the present disclosure has a structure in which at least two screens are connected in series. The roll blind 1 of the present disclosure includes a weight bar 300 at the lowermost end, a first screen 101 connected between the weight bar 300 and a first winding bar 100, and a second screen 201 connected between the first winding bar 100 and a second winding bar 200. An example having the first screen 101 and the second screen 201 is described in this embodiment, but screens, winding rolls, and winding bars may be additionally expanded. For example, expansion of connecting a third screen (not shown) between a third winding roll and the second winding bar 200 may be considered by disposing a third winding bar (not shown) over the second winding bar 200 and forming a third winding roll (not shown) in the third winding bar. Accordingly, the scope of the present disclosure is not limited to this embodiment.

The structure of the present disclosure is described hereafter sequentially from the lower end.

Referring to FIGS. 1 and 2, the weight bar 300 is disposed at the lowermost end of the roll blind 1. The weight bar 300 serves to extend the first screen 101 using its own weight. The weight bar 300 may be made of various materials and may be deformed in various shapes as long as it can perform this function. Accordingly, the shape of the weight bar 300 shown in the figures is an example.

Preferably, the weight bar 300 may be a bar-shaped structure having a length corresponding to the width of the first screen 101 (the width in a direction perpendicular to the extension direction of the screen (gravity direction)). In this embodiment, a holder 310 is formed at the weight bar 300.

As shown in FIG. 2, the holder 310 is formed to be able to fix the weight bar 300 to a side of window frame B. For example, the holder 310 may be a magnet that is disposed in the weight bar 300, etc. It is possible to fix the weight bar 300 to a metallic window frame B, etc. using the magnetism of a magnet. However, the holder may be changed, so it is not necessarily limited thereto.

For example, the holder 310 may be formed using other coupling structures that can be detachably coupled to the window frame B such as a clip and a hook that can be held on a window frame, etc.

As shown in FIG. 1, the first screen 101 is connected to the weight bar 300 at the lower end and connected to the first winding roll 110 at the upper end. Accordingly, the first screen 101 can be wound on the first winding roll 110 or unwound from the first winding roll 110 by rotation of the first winding roll 110. The first winding roll 110 is rotatably coupled in the first winding bar 100.

The first screen 101 has light transmissivity different from that of the second screen 201. In detail, any one of the first screen 101 and the second screen 201 may be made of a translucent sheet that can transmit light, and the other one may be made of an opaque sheet (a material blocking a visual field). Preferably, as in this embodiment, the first screen 101 may be made of a translucent sheet.

In this specification, an opaque sheet means a sheet that blocks the visual filed of a person because it is made of a material that cannot transmit the sunlight (or other types of incident light). Since an opaque sheet blocks a visual field, people substantially cannot see the outside view through an opaque sheet. On the other hand, a translucent sheet means a sheet that does not block the visual field of a person because it is made of a material that substantially partially transmits the sunlight (or other types of light) such as a colored or coated transmissive film. A translucent sheet does not block a visual field although its transmissivity for the visible light and/or other light (ultraviolet light and infrared light) excluding the visible light is adjusted through coloring and/or coating, so people can see the outside view through a translucent sheet.

Accordingly, the first screen 101 made of a translucent sheet can transmit light A. However, since a translucent state is provided, the transmittance is adjusted, whereby a common tinting effect is achieved. In this specification, tinting means adjusting the light amount of a material without interfering with a visual field by performing coloring and/or coating on the surface of a transmissive material. Accordingly, tinting includes removing light at specific wavelengths or reducing transmittance without changing a color such as UV protection coating. In this specification, tinting may be substantially the same meaning as the term “sunting” that Is commonly used.

The translucent sheet applied to the first screen 101 may be, for example, a transparent film having light transmissivity adjusted through tinting. The color of a translucent sheet can be freely adjusted, and the light transmissivity thereof can also be freely changed by adjusting the thickness of colors or coating, etc. Accordingly, even though the first screen 101 overlaps a window, a visual field is not blocked and only the transmissivity or transmittance of light A decreases.

The internal structure of the first winding roll 110 that winds or unwinds the first screen 101 is shown in FIG. 3. The internal structure of the first winding bar 100 having the first winding roll 110 therein is described with reference to FIG. 3.

As shown in FIG. 3, the upper end of the first screen 101 is connected to the first winding roll 110. The upper end of the first screen 101 may be fixed in close contact with the outer circumferential surface of the first winding roll 110 in various ways (e.g., bonding and/or pressing-fixing through a fixing member, etc.). Accordingly, when the first winding roll 110 is rotated, the first screen 101 is wound on the first winding roll 110 and inserted into the first winding bar 100, or is unwound from the first winding roll 110 and discharged from the lower end of the first winding bar 100.

The first winding roll 110 is rotatably coupled in the first winding bar 100. The first winding bar 100 may include a first body 120 formed in a long container shape with an internal accommodation space, and a first end cap 130 coupled to each of both ends of the first body 120. Both ends of the first winding roll 110 may be rotatably coupled to a shaft formed at the first end caps 130.

A method of coupling the first winding roll 110 to the first winding bar 100 through a shaft is exemplified as follows. For example, a rotary block 111 may be inserted in each of both ends of the first winding roll 110. The rotary block 111 may be hollow such that a shaft can pass through the center thereof, and the first winding roll 110 may be coupled to the first end caps 130 through the rotary blocks 111 at both ends.

The shaft formed at the first end cap 130 may be changed in various shapes, if necessary. An actuating structure, etc. may be disposed in the winding roll, so the shape or structure of the shaft may also be changed in correspondence to the structure. For example, as in this embodiment, when a spring-fixing shaft 113 connected to the first end cap 130 passes through the rotary block 111, the spring-fixing shaft 113 may operate as a rotation shaft of the first winding roll 110.

However, this is only one example, so the shaft structure may be modified in other types in other embodiments. For example, a rotation shaft (not shown) having another shape and connected to the first end cap 130 through the rotary block 111 may be formed at another end of the first winding roll 110 at which a spring-fixing shaft is not disposed.

The first winding bar 100 includes a torsion spring 110a connected to the first winding roll 110. The torsion spring 110a may be disposed in the first winding bar 100 and may be at least partially inserted in the first winding roll 110. The torsion spring 110a may be formed such that only one end thereof rotates with the first winding roll 110 with one end fixed to the first winding bar 100 using an appropriate structure.

The torsion spring 110a is connected to the first winding roll 110 and generates first torque (see T1 in FIG. 6) by being compressed by rotation of the first winding roll 110. Second torque (see T2 in FIG. 6) is generated in a pair in the opposite direction at the first winding roll 110 by the weight of the first screen 101 and the weight bar 300, and the pair of torques is precisely adjusted to be balanced (which will be described below in more detail).

That is, the torsion spring 110a of the first winding bar 100 is connected to the first winding roll 110 and generates first torque by being compressed by rotation of the first winding roll 110, and offsets the second torque generated in the opposite direction to the first torque by the weight of the first screen 101 and the weight bar 300 in rotation. Accordingly, the first screen 101 can be naturally fixed in an unwound state or a wound state by balance between the first torque and the second torque.

That is, the torsion spring 110a of the first winding bar 100 is formed to accurately offset second torque that increases or decreases depending on the unwound length of the first screen 101 (e.g., the load applied to the first winding roll by the first screen increases due to an increase in length of the first screen, and the torque (second torque) applied to the first winding roll in the unwinding direction of the first screen also increases due to the increased load) by first torque generated in the opposite direction. Accordingly, the first screen 101 is fixed at any position by balance of the torques, so it is possible to easily operate the first screen 101 even by a small external force. This will be described below in more detail.

A first end of the torsion spring 110a may be connected to the first end cap 130 to prevent rotation. For example, a first end of the torsion spring 110a may be fixed by a spring-fixing cap 112, and a spring-fixing shaft 113 connecting the spring-fixing cap 112 and the first end cap 130 may be formed. The spring-fixing shaft 113, as described above, may be formed through the rotary block 111.

A second end of the torsion spring 110a is connected to the first winding roll 110, thereby rotating with the first winding roll 110. Accordingly, when the first winding roll 110 is rotated, torsion is generated between the first end and the second end of the torsion spring 110a, whereby first torque is generated. For example, the second end of the torsion spring 110a may be connected to the first winding roll 110 by coupling a fitting block 114 that is fixedly fitted in the first winding roll 110.

The fitting block 114, for example, may be a cylindrical block with several blades or projections on the outer surface thereof. A protrusion 110b protruding inward and longitudinally extending is formed on the inner surface of the first winding roll 110 and can be coupled to the blades or the projections of the fitting block 114. This may be a kind of coupling type by prominences and recessions in which the protrusion 110b is inserted between the blades or the projections of the fitting block 114. It is possible to couple the fitting block 114 to the first winding roll 110 by applying various coupling types and induce torsion of the torsion spring 110a by rotation of the first winding roll 110.

An example of applying a single torsion spring 110a is shown in FIG. 3, but a plurality of torsion springs 110a may be distributed at both ends of the first winding roll 110 to generate appropriate torque. In this case, the elasticity of the torsion springs 110a may be appropriately adjusted in consideration of the number of the torsion springs 110a. In this way, it is possible to form the first winding bar 100 in which the first winding roll 110 and the torsion spring 110a are connected.

The second screen 201 is connected to the upper portion of the first winding bar 100.

Referring to FIG. 1, the second screen 201 is connected to the first winding bar 100 at the lower end and connected to the second winding roll 210 at the upper end. Accordingly, the second screen 201 can be wound on the second winding roll 210 or unwound from the second winding roll 210 by rotation of the second winding roll 210. The second winding roll 210 is rotatably coupled in the second winding bar 200.

The lower end of the second screen 201 is fixed to the first body (see 120 in FIG. 3) of the first winding bar 100, so it does not affect rotation of the first winding roll 110.

The second screen 201, as described above, may be made of an opaque sheet. The opaque sheet is not necessarily limited thereto, but, for example, may include fabric, etc. The opaque second screen 201 blocks light A, whereby a visual field can be blocked when the second screen 201 overlaps a window. In order to increase the effect of blocking light A, it is possible to extend the second screen 201 by unwinding the second screen 201 from the second winding roll 210.

The internal structure of the second winding roll 210 that winds or unwinds the second screen 201 is shown in FIG. 4. The internal structure of the second winding bar 200 having the second winding roll 210 installed therein is described with reference to FIG. 4.

As shown in FIG. 4, the upper end of the second screen 201 is connected to the second winding roll 210. The upper end of the second screen 201 is fixed in close contact with the outer circumferential surface of the second winding roll 210 in various ways (e.g., bonding and/or pressing-fixing through a fixing member, etc.). Accordingly, when the second winding roll 210 is rotated, the second screen 201 is wound on the second winding roll 210 and inserted into the second winding bar 200, or is unwound from the second winding roll 210 and discharged from the lower end of the second winding bar 200.

The second winding roll 210 is rotatably coupled in the second winding bar 200. The coupling structure of the second winding roll 210 and the second winding bar 200 may be similar to the above-mentioned coupling structure of the first winding roll 110 and the first winding bar 100. The coupling structure of the second winding roll 210 and the second winding bar 200 is described hereafter with reference to the coupling structure of the first winding roll and the first winding bar.

The second winding bar 200 may include a second body 220 formed in a long hollow container shape, and a second end cap 230 coupled to each of both ends of the second body 220. Both ends of the second winding roll 210 may be rotatably coupled to a shaft formed at the second end caps 230. The second winding bar 200 may be formed slightly larger than the first winding bar 100 to keep the opaque second screen 201 (of which the fabric may be relatively thick due to the material).

A method of coupling both ends of the second winding roll 210 to the second winding bar 200 through a shaft is exemplified as follows. A rotary block 211 may be inserted in each of both ends of the second winding roll 210 and may be hollow so that a shaft can pass through the center thereof. Accordingly, the second winding roll 210 may be coupled to the second end caps 230 through the rotary blocks 211 at both ends.

The shaft formed at the second end cap 230 may be changed in various shapes, if necessary. An actuating structure, etc. may be disposed in the winding roll, so the shape or structure of the shaft may also be changed in correspondence to the structure. For example, when a motor-fixing shaft 214 and a spring-fixing shaft 218 are disposed through the rotary blocks 211 at both ends, respectively, as in this embodiment, the motor-fixing shaft 214 and the spring-fixing shaft 218 can function as a rotation shaft of the second winding roll 210.

The second winding bar 200 may include a rotation actuator 210a that applies a rotation force to the second winding roll 210. The rotation actuator 210a can simultaneously adjust the positions of the second screen 201 and the first winding bar 100 connected to the lower end of the second screen 201 by applying a rotation force to the second winding roll 210. The second winding bar 200 may be positioned relatively high, so the rotation actuator 210a may be configured to be able to be operated at a remote position.

Preferably, the rotation actuator 210a may include a driving motor 212 that can be remotely controlled. The driving motor 212 may be controlled, for example, through a wired or wireless remote controller (not shown). Further, a battery (not shown) for supplying power to the driving motor 212 may be disposed at a side of the second winding bar 200.

However, the present disclosure is not necessarily limited thereto and, in another embodiment, the rotation actuator may include another remotely controllable structure (e.g., connected to an operation string-second winding roll through a gear). A driving motor may be disposed in this configuration. It is possible to drive the second winding roll 210 using other types of driving structures.

The driving motor 212 may be connected and fixed to the second end cap 230. For example, it is possible to fix the driving motor 212 by coupling the body of the driving motor 212 to a motor-fixing cap 213 and forming a motor-fixing shaft 214 connecting the motor-fixing cap 213 and the second end cap 230. The motor-fixing shaft 214, as described above, may be formed through the rotary block 211.

The shaft of the driving motor 212 is connected to the second winding roll 210. Accordingly, the rotation force of the driving motor 212 can be applied to the second winding roll 210. The shaft of the driving motor 212 may be connected to the second winding roll 210 by coupling a fitting block 215 that is fixedly fitted in the second winding roll 210. The shaft of the driving motor 212 may be connected to a reducer that can change torque, etc., and such a reducer may be integrally formed with the driving motor 212.

Meanwhile, an assistant force generator 210b that accumulates elastic energy and assists rotation using the accumulated elastic energy in rotation may be additionally disposed at the second winding roll 210. The assistant force generator 210b may have a similar shape to the torsion spring described above because it includes an elastic member, but it is different because it is used to accumulate a predetermined amount of elastic energy in rotation.

The assistant force generator 210b may include an assistant spring 216 and the assistant spring 216 may be configured to accumulate elastic energy through torsion.

The assistant spring 216 has a first end connected to the second end cap 230 to be fixed without rotating and a second end connected to the second winding roll 210, whereby the assistant spring 216 can be twisted. For example, a spring-fixing cap 217 may be coupled to the first end of the assistant spring 216, and a spring-fixing shaft 218 connecting the spring-fixing cap 217 and the second end cap 230 may be formed. The spring-fixing shaft 218 may be formed through the rotary block 211. The second end of the assistant spring 216 may be connected to the second winding roll 210 by coupling a fitting block 219 that is fixedly fitted in the second winding roll 210.

The fitting blocks 215 and 219 applied to the assistant spring 216 and the driving motor 212 may have substantially the same structure. The respective fitting blocks 215 and 219 may be cylindrical blocks with several blades or projections on the outer surface thereof. A protrusion 210c protruding inward and longitudinally extending is formed on the inner surface of the second winding roll 210 and can be coupled to the blades or the projections of each of the fitting blocks 215 and 219. It is possible to connect a side of the driving motor 212 and a side of the assistant spring 216 each to the second winding roll 210 in this way.

According to this structure, it is possible to form a serial type multi roll blind 1 including the first winding bar 100, the second winding bar 200, and the first screen 101 and the second screen 201 connected between the winding bars.

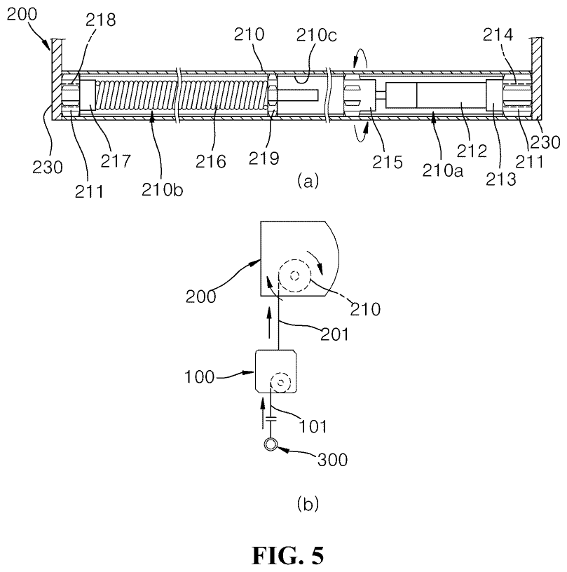

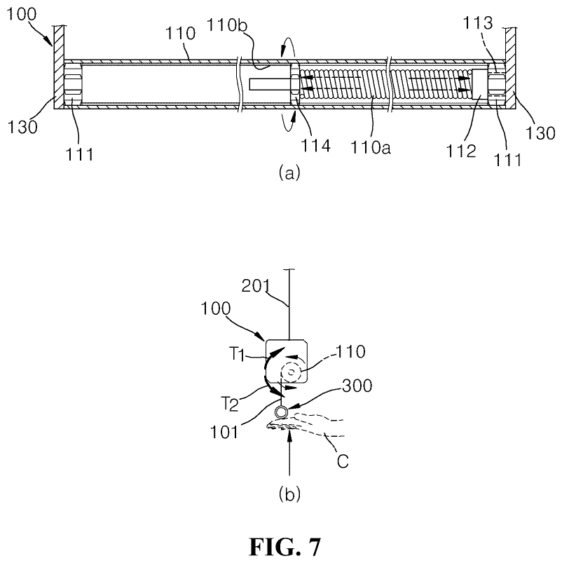

FIG. 5 is an operation view exemplifying the operation of the second winding bar and the second screen of the roll blind of FIG. 1, and FIGS. 6 and 7 are operation views exemplifying the operation of the first winding bar and the first screen of the roll blind of FIG. 1.

According to the structure described above, the first screen and the second screen can be operated as follows. First, referring to FIG. 5, it is possible to adjust the extended length of the second screen 201 using the rotation actuator 210a. As shown in FIG. 5, when a rotation force is applied to the second winding roll 210 by rotating the driving motor 212 described above in one direction, the second winding roll 210 can wind the second screen 201 while rotating. The operation of the second winding roll 210 winding the second screen 201 is shown in FIG. 5, but when the rotation direction of the driving motor 212 is changed to the opposite direction, the second screen 201 is unwound and extended.

As described above, the second winding bar 200 may be operated by the rotation actuator 210a that actively applies a rotation force to the second winding roll 210. When the second winding roll 210 is rotated, the second screen 201 is moved up and down and the position of the first winding roll 110 connected to the lower end of the second screen 201 is also changed.

Accordingly, as in FIG. 5, it is possible to simultaneously operate the second screen 201, the first winding bar 100, and the first screen 101 connected to the first winding bar 100 by rotating the second winding roll 210. As will be described below, when the weight bar 300 at the end of the first screen 101 is not specifically fixed, it is possible to simultaneously move up and down the first screen 101 and the second screen 201 by driving the second winding roll 210, as described above.

Meanwhile, referring to FIGS. 6 and 7, the first screen 101 can be more simply operated using the pair of first torque T1 and second torque T2 that is generated and offset by rotation of the first winding roll 110 and makes balance of force. As shown in FIG. 6, even though the weight bar 300 at the lower end of the first screen 101 is slightly pulled by hand C, the first screen 101 is easily unwound from the first winding roll 110 with the balance of torques maintained by a simple pull. The first torque T1 and the second torque T2 are offset in opposite directions and the balance of force can be maintained even during rotation.

Accordingly, a user does not need to keep pulling the weight bar 300 by hand C, and when the user wind out the first screen 101 to a desired length and then takes the hand C off, the state in which there is substantially no external force by balance of the first torque T1 and the second torque T2 is made, so the first screen 101 is naturally fixed in the unwound state.

Variation of torque when the first screen 101 is operated is as follows. The unwound length of the first screen 101 increases in unwinding, as in (b) of FIG. 6, so the second torque T2 acting downward to the first screen 101 increases. However, as in (a) of FIG. 6, since the torsion spring 110a is compressed by the same rotation, the first torque T1 generated in the opposite direction to the second torque T2 (that is, generated by restoring force proportional to compression of the torsion spring) also increases. The first torque T1 offsets the second torque T2, whereby forces are balanced and the first screen 101 is naturally stopped at the corresponding position.

Balance of torques is not generated at specific positions and is generated at any rotation angle of the first winding roll 110. Accordingly, even though a position is changed, only the magnitude of torques that are offset by each other changes and the first screen 101 is naturally stopped at any position.

The first torque T1 and the second torque T2 can be offset through the following principle.

The magnitude of the first torque T1 is proportional to the degree of compression of the torsion spring 110a, and compression of the torsion spring 110a is proportional to the rotation angle of the first winding roll 110 (the rotation angle of the first winding roll 110 around a rotation center). Accordingly, the first torque T1 can be finally determined as the product of a rotation angle by a specific proportional factor. Assuming that an initial torque value is provided in a general case, it can be expressed into a linear expression, (rotation angle)×(first proportional factor)+(first initial torque value).

Meanwhile, the magnitude of the second torque T2 is the same as the sum of the torque of the first screen 101, which is the product of the load applied to a side of the first winding roll 110 by the first screen 101 by the radius of the first winding roll 110 (corresponding to the arm of torque)(the product is a vector product, but the value is the same as a common product because the first screen is pulled in a tangential direction (direction perpendicular to the radius) on the side of the first winding roll), and the torque of the weight bar 300 which is a constant.

In this case, assuming that the width, density, and thickness of the first screen 101 and the radius of the first winding roll 110 are constants (which are substantially not changed in common situations), the load applied by the first screen 101 is proportional to the unwound length of the first screen 101 (the mass increases in proportion to the length and the load increases in proportion to the mass). The unwound length of the first screen 101 (=(radius of first winding roll)×(rotation angle)) is proportional to the rotation angle of the first winding roll 110 in accordance with circular measure, so the second torque T2 can also be determined as a linear expression of multiplying a rotation angle by a specific proportional factor and then adding a constant corresponding to the value of weight bar torque. This can be expressed as (rotation angle)×(second proportional factor)+(weight bar torque).

In more detail, referring to a known torque formula of the torsion spring 110a, it can be obtained that (first torque (T1))=(rotation angle)×[(wire diameter of torsion spring)⁴×(Young's modulus of torsion spring)]/[64×(diameter of torsion spring)×(number of times of winding of torsion spring)]+(first initial torque value). Accordingly, the (first proportional factor) can be set as a value desired by a user (manufacturer) by adjusting the wire diameter, Young's modulus, and the number of times of winding of the torsion spring.

Further, second torque (T2)=(torque of first screen)+(weight bar torque), but (torque of first screen)=(radius of first winding roll)×(load of unwound first screen), (load of unwound first screen)=(density of first screen)×(width of first screen)×(thickness of first screen)×(acceleration of gravity), and (length of unwound first screen)=(rotation angle)×(radius of first winding roll), so it can be obtained that second torque (T2)=(rotation angle)×(radius of first winding roll)²×(density of first screen)×(width of first screen)×(thickness of first screen)×(acceleration of gravity)+(weight bar torque). Accordingly, the (second proportional factor) can be set as a value desired by user (manufacturer) by adjusting the radius of the first winding roll, and the density, width, and thickness of the first screen.

Further, since the weight bar torque (=(weight bar load)×(radius of first winding roll)) is a value proportional to the load of the weight bar, the weight bar torque can be set as a value desired by a user (manufacturer), and the initial first torque value can also be set as a desired value by using a torsion spring (the rotation angles described in the above expressions are all the rotation angles of the first winding roll).

Accordingly, since first torque (T1)=(rotation angle)×(first proportional factor)+(initial first torque value) and second torque (T2)=(rotation angle)×(second proportional factor)+(weight bar torque), the first torque T1 and the second torque T2 both can be expressed as a linear function about the rotation angle of the first winding roll 110. Further, since the first proportional factor, the second proportional factor, the weight bar torque, and the initial first torque value can also be adjusted into desired values, the manufacturing variables described above (the wire diameter, Young's modulus, diameter, the number of times of winding of the torsion spring, the radius of the first winding roll, the density, width, and thickness of the first screen, the load of the weight bar, and the initial first torque value) can be set as appropriate values such that the equation, first torque (T1)=second torque (T2) is satisfied by adjusting the first proportional factor, the second proportional factor, the weight bar torque, and the initial first torque value.

It is possible to offset the first torque T1 and the second torque T2 as substantially equivalent magnitudes at all of rotation angles by adjusting some variables in this way.

In this case, the first proportional factor and the second proportional factor each correspond to the slope of the linear function described above, so when the first proportional factor and the second proportional factor are made the same, the increase ratio (to the rotation angle) of the first torque T1 and the increase ratio (to the rotation angle) of the second torque T2 are made the same, making it possible to more minutely make the first torque T1 and the second torque T2 the same when the rotation angle changes. Further, the weight bar torque, which is a kind of initial second torque value, can be used to adjust the start values of the first torque T1 and the second torque T2 to be the same.

Since, in this way, it is possible to make the first torque T1 and the second torque T2 the same regardless of the rotation angle of the first winding roll 110, it is possible to naturally stop the first screen 101 by offsetting the second torque T2 by the first torque T1 in any case in which the first screen 101 has been unwound, as in FIG. 6, or has been wound, as in FIG. 7.

However, when the first screen 101 is pushed up to be wound, as in FIG. 7, the unwound length of the first screen 101 is decreased, so the load applied by the first screen 101 is reduced, whereby the magnitude of the second torque T2 is decreased and the torsion spring 110a is stretched by reduction of the rotation angle of the first winding roll 110. Accordingly, there is only the difference that the magnitude of the first torque T1 offsetting the second torque T2 is correspondingly reduced.

Accordingly, a user can easily unwind the first screen 101 from the first winding roll 110 or wind he first screen 101 on the first winding roll 110 only by applying a very small external force. Further, since the first screen 101 is naturally fixed at all points, at which the position thereof is adjusted, by balance of torques, there is no need for a specific fixing device.

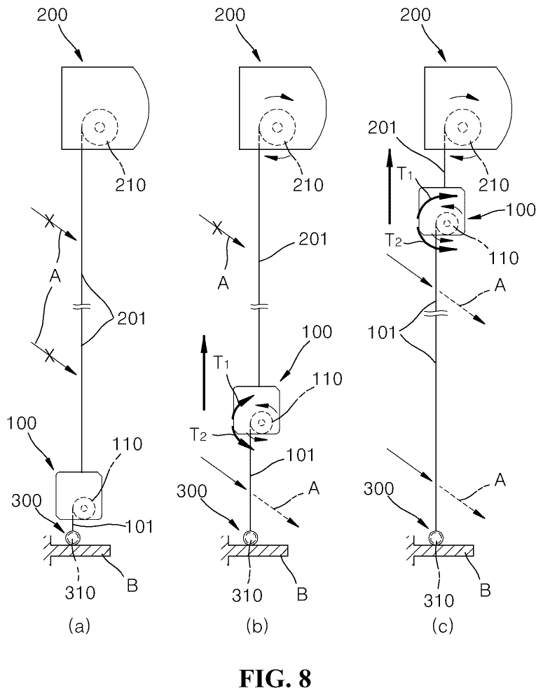

According to the present disclosure, it is possible to automatically change the ratio of the first screen 101 and the second screen 201 with the weight bar 300 fixed, as follows, using this structure. Hereafter, operation with the weight bar fixed is exemplarily described with reference to FIG. 8.

FIG. 8 is an operation view showing the operation of the roll blind of FIG. 1 step by step with a weight bar fixed.

Referring to FIG. 8, it is possible to fix the weight bar 300 to the window frame B using the holder 310 described above. However, when there is no holder, the operation to be described below can be achieved by putting a weight body on the weight bar 300 or by a person holding the weight bar 300.

For example, as in (a) of FIG. 8, it is possible to fix first the weight bar 300 and then unwind the second screen 201 longer than the first screen 101. This initial state is exemplified for description and does not need to be understood in a limitative manner.

When the second winding roll 210 is driven in this state, as in (b) of FIG. 8, the second screen 201 is unwound and the first winding bar 100 is correspondingly moved up. Since the weight bar 300 is fixed, the more the first winding bar 100 is moved up, the wider the first screen 101 is extended.

That is, by driving the second winding roll 210 with the weight bar 300 fixed, it is possible to reduce the extended length of the second screen 201 and simultaneously increase the extended length of the first screen 101. In this case, also, the first torque T1 and the second torque T2 increase to the same magnitude and offset each other, thereby maintaining balance, regardless of whether the first screen 101 is wound or unwound. Accordingly, the extended length of the first screen 101 is maintained.

Accordingly, it is possible to adjust the first screen 101 to a different length while moving up the first winding bar 100, as in (c) of FIG. 8, or moving down the first winding bar 100, as in (a) of FIG. 8. Since the second winding roll 210 is driven by the rotation actuator described above, it is possible to simultaneously change the ratio of the first screen 101 and the second screen 201 by controlling the rotation actuator with the weight bar 300 fixed.

Accordingly, it is possible to block light A traveling inside through a window by the second screen 201 made of an opaque sheet by expanding the area of the second screen 201 overlapping the window, as in (a) of FIG. 8. Further, as in (c) of FIG. 8, it is possible to reduce the amount of light and see the outside view by the first screen made of a translucent sheet by expanding the area of the first screen 101 overlapping a window. Further, as in (b) of FIG. 8, it is also possible to maintain appropriate lighting that a user wants by adjusting the areas of the first screen 101 and the second screen 201 at an appropriate ratio.

Further, not being limited to the above, by separating the weight bar 300 from a window frame B and then driving the second winding roll 210, it is possible to move up the first screen 101 and the second screen 201 at a time, so it is also possible to completely expose a portion of a window. Further, even when the second screen 201 is fixed or moving, it is possible to operate the first screen 101 anytime through a simple touch, so a user can increase or decrease the length by operating the first screen 101 at a desired point in time. In this manner, it is possible to use the blind in various ways in correspondence to various demands of users in various situations.

Although exemplary embodiments of the present disclosure were described above with reference to the accompanying drawings, those skilled in the art would understand that the present disclosure may be implemented in various ways without changing the necessary features or the spirit of the prevent disclosure. Therefore, the embodiments described above are only examples and should not be construed as being limitative in all respects.

### INDUSTRIAL APPLICABILITY

The present disclosure can block the sunlight or adjust the amount of light by applying at least two kinds of continuously connected screens to one window. Further, it is also possible to block the sunlight using an opaque screen, to see the view outside a widow while giving a tinting effect using a translucent screen, and to transmit the sunlight by fully winding up a screen itself. Further, by longitudinally dividing one window using continuously connected screens, customized operation can also be achieved such as blocking a portion of a window, tinting a portion, and transmitting the sunlight through a portion. These effects are effects that can be achieved by applying the present disclosure to building with windows, so it is possible to achieve various effects including the above effects by applying the present disclosure to any buildings that are used for any purposes regardless of a work space, a dwelling space, etc. Accordingly, the present disclosure can be used in all kinds of industries related to buildings and the spaces in buildings, so the industrial applicability is high.

1. A serial type multi roll blind comprising:
a weight bar;
a first screen that has a lower end connected to the weight bar and an upper end connected to a first winding roll and is wound on the first winding roll or unwound from the first winding roll by rotation of the first winding roll;
a first winding bar in which the first winding roll is rotatably coupled;
a second screen that has a lower end connected to the first winding bar and an upper end connected to a second winding roll and is wound on the second winding roll or unwound from the second winding roll by rotation of the second winding roll; and
a second winding bar in which the second winding roll is rotatably coupled.

2. The serial type multi roll blind of claim 1, wherein the first winding bar includes a torsion spring that is connected to the first winding roll and generates first torque while being compressed by rotation of the first winding roll, thereby offsetting second torque that is generated in the opposite direction to the first torque by the weight of the first screen and the weight bar in rotation.

3. The serial type multi roll blind of claim 2, wherein the first screen is naturally fixed in an unwound state or a wound state by balance of the first torque and the second torque.

4. The serial type multi roll blind of claim 3, further comprising a holder disposed at the weight bar to be able to fix the weight bar to a side of a window frame.

5. The serial type multi roll blind of claim 4, wherein the second winding bar further includes a rotation actuator adjusting positions of the second screen and the first winding bar by applying a rotation force to the second winding roll.

6. The serial type multi roll blind of claim 5, wherein the rotation actuator includes a remotely controllable driving motor.

7. The serial type multi roll blind of claim 1, wherein the first screen and the second screen are different in light transmissivity.

8. The serial type multi roll blind of claim 7, wherein any one of the first screen and the second screen is made of a translucent sheet that can transmit light and the other one is made of an opaque sheet.

9. The serial type multi roll blind of claim 8, wherein the translucent sheet is a transparent film having light transmissivity adjusted through tinting.

10. The serial type multi roll blind of claim 8, wherein the first screen is made of a translucent sheet and the second screen is made of an opaque sheet.
